(19) United States
(12) Patent Application Publication
(10) Pub. No.: US 2024/0413486 A1
(43) Pub. Date: Dec. 12, 2024

(54) ZINC SECONDARY BATTERY

(71) Applicant: NGK INSULATORS, LTD., Nagoya-shi (JP)

(72) Inventor: Junki MATSUYA, Chita-gun (JP)

(21) Appl. No.: 18/810,777

(22) Filed: Aug. 21, 2024

Related U.S. Application Data
(63) Continuation of application No. PCT/JP2022/039698, filed on Oct. 25, 2022.

(30) Foreign Application Priority Data
Feb. 25, 2022 (JP) 2022-028175

(51) Int. Cl. H01M 50/466; H01M 10/28; H01M 50/417; H01M 50/431; H01M 50/451

(52) U.S. Cl. CPC H01M 50/466; H01M 10/28; H01M 50/417; H01M 50/431; H01M 50/451

(57) ABSTRACT

Provided is a zinc secondary battery including a positive electrode plate including a positive electrode active material layer; a negative electrode plate including a negative electrode active material layer; a hydroxide ion conductive separator that is in a bag-like form for housing the negative electrode plate; an electrolytic solution; and a battery case in which the positive electrode plate, the negative electrode plate, and the hydroxide ion conductive separator are vertically housed. The negative electrode active material layer extends to a position lower than a lower end of the positive electrode active material layer, a height from a bottom of the battery case of a lower end of the negative electrode active material layer is 2.0 to 8.0 mm, and a height difference between the lower end of the positive electrode active material layer and the lower end of the negative electrode active material layer is 3.0 to 4.0 mm.

### CROSS-REFERENCE TO RELATED APPLICATIONS

This application is a continuation application of PCT/JP2022/039698 filed Oct. 25, 2022, which claims priority to Japanese Patent Application No. 2022-028175 filed Feb. 25, 2022, the entire contents all of which are incorporated herein by reference.

### BACKGROUND OF THE INVENTION

### 1. Field of the Invention

The present disclosure relates to a zinc secondary battery.

### 2. Description of the Related Art

It is known that in zinc secondary batteries such as a nickel-zinc secondary battery and an air-zinc secondary battery, metallic zinc in a dendrite form precipitates from a negative electrode upon charge, penetrates voids of a separator such as a nonwoven fabric, and reaches a positive electrode, resulting in occurrence of a short circuit. This short circuit due to such zinc dendrites leads to shorten repeated charge/discharge life.

In order to deal with the problems described above, a battery comprising a layered double hydroxide (LDH) separator that blocks the penetration of zinc dendrite while selectively permeating hydroxide ions has been proposed. For example, Patent Literature 1 (WO2013/118561) discloses a nickel-zinc secondary battery including a LDH separator provided between a positive electrode and a negative electrode. Patent Literature 2 (WO2016/076047) discloses a separator structure comprising an LDH separator fitted or joined to a resin outer frame, wherein the LDH separator has a high denseness such that it has a gas impermeability and/or water impermeability. Moreover, the literature also discloses that the LDH separator can be composited with a porous substrate. Further, Patent Literature 3 (WO2016/067884) discloses various methods for forming an LDH dense membrane on a surface of a porous substrate to obtain a composite material. This method comprises steps of uniformly adhering a starting material that can impart a starting point for LDH crystal growth to the porous substrate, treating hydrothermally the porous substrate in a raw material aqueous solution to form an LDH dense membrane on a surface of the porous substrate. An LDH separator further densified by roll pressing of a composite material of an LDH/porous substrate produced by hydrothermal treatment has been also proposed. For example, Patent Literature 4 (WO2019/124270) discloses an LDH separator comprising a polymer porous substrate, and an LDH filled in the porous substrate, and having a linear transmittance at a wavelength of 1000 nm of 1% or more.

Moreover, LDH-like compounds have being known as hydroxides and/or oxides with a layered crystal structure that cannot be called LDH but are analogous thereto, which exhibit hydroxide ion conductive properties similar to those of a compound to an extent that it can be collectively referred to as hydroxide ion conductive layered compounds together with LDH. For example, Patent Literature 5 (WO2020/255856) discloses a hydroxide ion conductive separator comprising a porous substrate and a layered double hydroxide (LDH)-like compound that clogs up pores in the porous substrate, in which the LDH-like compound is a hydroxide and/or an oxide with a layered crystal structure containing Mg, and one or more elements including at least Ti and selected from the group consisting of Ti, Y and Al. It is described that this hydroxide ion conductive separator is excellent in alkali resistance as compared with a conventional LDH separator, and can further effectively inhibit a short circuit due to zinc dendrite.

By the way, Patent Literature 6 (WO2019/069760) and Patent Literature 7 (WO2019/077953) have proposed a zinc secondary battery having a configuration in which the whole of a negative electrode active material layer is covered or wrapped up with a liquid holding member and an LDH separator, and a positive electrode active material layer is covered or wrapped up with a liquid holding member. As the liquid holding member, a nonwoven fabric is used. It is described that according to such a configuration, complicated sealing and bonding between the LDH separator and a battery container is unnecessary, and hence a zinc secondary battery (especially a stacked-cell battery thereof) capable of preventing zinc dendrite propagation can be produced extremely easily and with high productivity.

### CITATION LIST

### Patent Literature

Patent Literature 1: WO2013/118561
Patent Literature 2: WO2016/076047
Patent Literature 3: WO2016/067884
Patent Literature 4: WO2019/124270
Patent Literature 5: WO2020/255856
Patent Literature 6: WO2019/069760
Patent Literature 7: WO2019/077953

### SUMMARY OF THE INVENTION

In Patent Literatures 6 and 7, the configuration in which a negative electrode active material layer is covered or wrapped up with a hydroxide ion conductive separator is employed for preventing zinc dendrite propagation. When, however, a charge/discharge cycle is repeated in a zinc secondary battery 100 having this configuration, a defect D of a hydroxide ion conductive separator 16 may occur in a lower end sealing portion of the hydroxide ion conductive separator 16 surrounding a negative electrode active material layer 14a as illustrated in FIG. 6. When such a defect D occurs, in accordance with the repetition of the charge/discharge cycle, metal zinc derived from the negative electrode active material layer 14a precipitates and deposits, through the defect D, on the bottom of a battery case 20, and at the worst case, the metal zinc thus deposited reaches a lower end of a positive electrode plate 12, which can cause a short circuit S.

The inventors have now found that, in a zinc secondary battery having a configuration in which a negative electrode plate is housed in a bag-like hydroxide ion conductive separator, a short circuit due to a defect caused in a lower end sealing portion of the bag-like hydroxide ion conductive separator becomes less likely to occur by extending a negative electrode active material layer to a position lower than a lower end of a positive electrode active material layer, and controlling the height of a lower end of the negative electrode active material layer, and a height difference between the lower end of the positive electrode active material layer and the lower end of the negative electrode active material layer.

Accordingly, an object of the present invention is to provide a zinc secondary battery in which a short circuit due to a defect caused in a lower end sealing portion of a bag-like hydroxide ion conductive separator is less likely to occur.

The present invention provides the following aspects:

### [Aspect 1]

A zinc secondary battery comprising:
a positive electrode plate including a positive electrode active material layer;
a negative electrode plate including a negative electrode active material layer containing at least one selected from the group consisting of zinc, zinc oxide, a zinc alloy, and a zinc compound;
a hydroxide ion conductive separator that is in a bag-like form for housing the negative electrode plate therein, and separates the positive electrode plate and the negative electrode plate so as to make hydroxide ions conductable;
an electrolytic solution; and
a battery case in which the positive electrode plate, the negative electrode plate, and the hydroxide ion conductive separator are vertically housed,
wherein the negative electrode active material layer extends to a position lower than a lower end of the positive electrode active material layer, and
wherein a height from a bottom of the battery case of a lower end of the negative electrode active material layer is 2.0 to 8.0 mm, and a height difference between the lower end of the positive electrode active material layer and the lower end of the negative electrode active material layer is 3.0 to 4.0 mm.

### [Aspect 2]

The zinc secondary battery according to aspect 1, wherein the bag-like hydroxide ion conductive separator includes a lower end sealing portion sealed by thermal welding or ultrasonic welding of portions of the hydroxide ion conductive separator.

### [Aspect 3]

The zinc secondary battery according to aspect 1 or 2, wherein not only the hydroxide ion conductive separator but also a liquid holding member is interposed between the positive electrode plate and the negative electrode plate.

### [Aspect 4]

The zinc secondary battery according to aspect 3, wherein the positive electrode plate and/or the negative electrode plate is covered or wrapped up with the liquid holding member.

### [Aspect 5]

The zinc secondary battery according to aspect 3 or 4, wherein the liquid holding member is a nonwoven fabric.

### [Aspect 6]

The zinc secondary battery according to aspect 5, wherein the nonwoven fabric has a thickness of 10 to 200 μm.

### [Aspect 7]

The zinc secondary battery according to any one of aspects 1 to 6, wherein the hydroxide ion conductive separator is an LDH separator containing a layered double hydroxide (LDH) and/or an LDH-like compound.

### [Aspect 8]

The zinc secondary battery according to aspect 7, wherein the LDH separator further includes a porous substrate, and is composited with the porous substrate with the LDH and/or the LDH-like compound filled in pores in the porous substrate.

### [Aspect 9]

The zinc secondary battery according to aspect 8, wherein the porous substrate is made of a polymer material.

### [Aspect 10]

The zinc secondary battery according to any one of aspects 7 to 9, wherein the LDH separator has a thickness of 5 to 100 μm.

### [Aspect 11]

The zinc secondary battery according to any one of aspects 1 to 10, wherein the positive electrode active material layer contains nickel hydroxide and/or nickel oxyhydroxide, whereby the zinc secondary battery is configured as a nickel-zinc secondary battery.

### [Aspect 12]

The zinc secondary battery according to any one of aspects 1 to 10, wherein the positive electrode active material layer is an air electrode layer, whereby the zinc secondary battery is configured as an air-zinc secondary battery.

### [Aspect 13]

The zinc secondary battery according to any one of aspects 1 to 12, comprising a plurality of unit cells each including a pair of the positive electrode plate and the negative electrode plate together with the hydroxide ion conductive separator, whereby the plurality of the unit cells form a multilayer cell as a whole.

### BRIEF DESCRIPTION OF THE DRAWINGS

FIG. 1 is a schematic cross-sectional view illustrating an example of a zinc secondary battery of the present invention.

FIG. 2 is a view schematically illustrating A-A′ cross section of the zinc secondary battery shown in FIG. 1.

FIG. 3 is a perspective view schematically illustrating battery components of the zinc secondary battery shown in FIG. 1.

FIG. 4 is a cross-sectional view schematically illustrating arrangement of a positive electrode active material layer and a negative electrode active material layer of the zinc secondary battery shown in FIG. 1.

FIG. 5 is a diagram for explaining a short circuit suppression mechanism in the zinc secondary battery of the present invention.

FIG. 6 is a diagram for explaining a short circuit generation mechanism of a conventional zinc secondary battery.

### DETAILED DESCRIPTION OF THE INVENTION

### Zinc Secondary Battery

A zinc secondary battery of the present invention is not especially limited as long as it is a secondary battery using zinc as a negative electrode and using an alkaline electrolytic solution (representatively, an alkali metal hydroxide aqueous solution). Accordingly, it can be a nickel-zinc secondary battery, a silver oxide-zinc secondary battery, a manganese oxide-zinc secondary battery, an air-zinc secondary battery, or any of other various alkaline zinc secondary batteries. For example, it is preferred that a positive electrode active material layer contains nickel hydroxide and/or nickel oxyhydroxide, whereby the zinc secondary battery is configured as a nickel-zinc secondary battery. Alternatively, a positive electrode active material layer may be an air electrode layer, whereby the zinc secondary battery is configured as an air-zinc secondary battery.

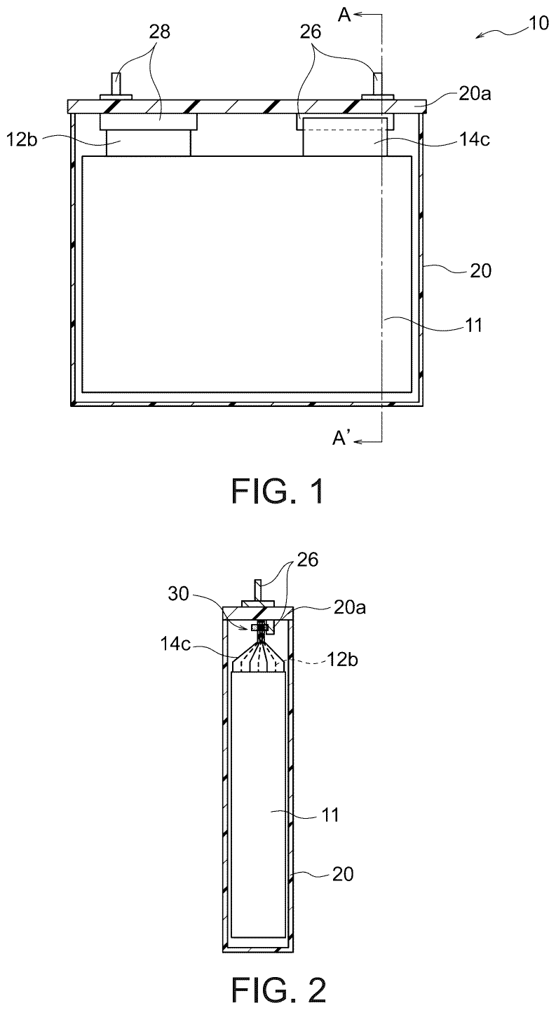

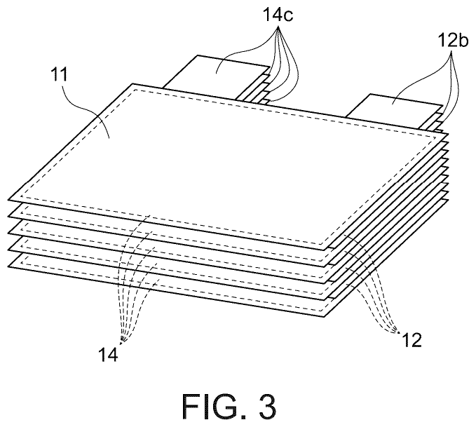

FIGS. 1 to 5 illustrate a zinc secondary battery 10 according to one aspect of the present invention. The zinc secondary battery 10 includes battery components 11 housed in a battery case 20, and the battery components 11 include unit cells 10a each including a positive electrode plate 12, a negative electrode plate 14, a hydroxide ion conductive separator 16, and an electrolytic solution 18. The positive electrode plate 12 includes a positive electrode active material layer 12a. The negative electrode plate 14 includes a negative electrode active material layer 14a. The negative electrode active material layer 14a contains at least one selected from the group consisting of zinc, zinc oxide, a zinc alloy, and a zinc compound. The hydroxide ion conductive separator 16 is in a bag-like form for housing the negative electrode plate 14 therein, and separates the positive electrode plate 12 and the negative electrode plate 14 such that hydroxide ions can be conducted. In the battery case 20, the positive electrode plate 12, the negative electrode plate 14, and the hydroxide ion conductive separator 16 are vertically housed. The negative electrode active material layer 14a extends to a position lower than a lower end of the positive electrode active material layer 12a. A height B from the bottom of the battery case 20 of the lower end of the negative electrode active material layer 14a is 2.0 to 8.0 mm, and a height difference A between the lower end of the positive electrode active material layer 12a and the lower end of the negative electrode active material layer 14a is 3.0 to 4.0 mm. In this manner, by extending the negative electrode active material layer 14a to the position lower than the lower end of the positive electrode active material layer 12a, and controlling the height B of the lower end of the positive electrode active material layer 14a and the height difference A between the lower end of the positive electrode active material layer 12a and the lower end of the negative electrode active material layer 14a, a short circuit due to a defect otherwise caused in a lower end sealing portion of the bag-like hydroxide ion conductive separator 16 becomes less likely to occur.

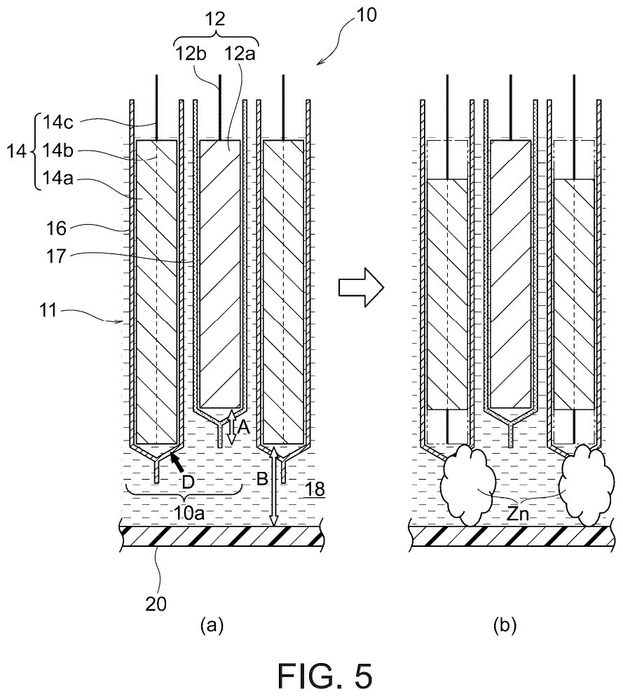

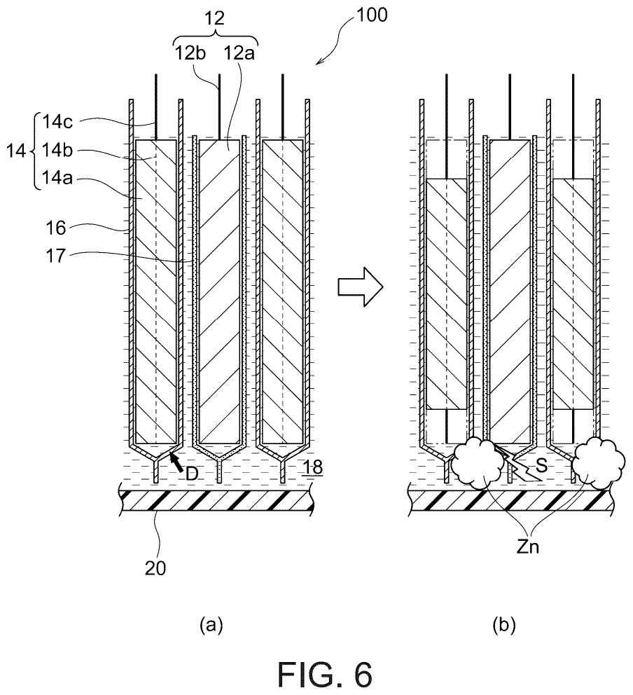

Specifically, as described above referring to FIG. 6, when a charge/discharge cycle is repeated in a conventional zinc secondary battery 100 having the configuration in which the negative electrode active material layer 14a is covered or wrapped up with the hydroxide ion conductive separator 16, a defect D of the hydroxide ion conductive separator 16 may be caused in a lower end sealing portion of the hydroxide ion conductive separator 16 surrounding the negative electrode active material layer 14a. The formation of such a defect D is probably caused by expansion/shrinkage of the negative electrode active material layer 14a through the charge/discharge cycle. In particular, the lower end sealing portion of the hydroxide ion conductive separator 16 is typically formed by thermal welding or ultrasonic welding of portions of the hydroxide ion conductive separator 16, and a defect D can be caused in such a welded portion. When such a defect D is caused, in accordance with the repetition of the charge/discharge cycle, metal zinc derived from the negative electrode active material layer 14a precipitates and deposits, through the defect D, on the bottom of a battery case 20, and at the worst case, the metal zinc thus deposited reaches the lower end of a positive electrode plate 12, which can cause a short circuit S. Specifically, since the negative electrode active material layer 14a is changed in its shape in accordance with the repetition of the charge/discharge cycle, a precipitate of metal zinc detached from the negative electrode active material layer 14a through the shape change passes, with gravity, through the defect D to move to and deposit on the bottom of the battery case 20. Thus, as the amount of the deposit of metal zinc increases, the height of the deposit increases, and ultimately, the deposit reaches the lower end of the positive electrode plate 12, and as a result, a short circuit S can occur. In this regard, in the configuration of the zinc secondary battery 10 of the present invention, as illustrated in FIG. 5, even when metal zinc derived from the negative electrode active material layer 14a precipitates and deposits through the defect D on the bottom of the battery case 20, the deposit can be accumulated in a lower extra space significantly lower than the lower end of the positive electrode active material layer 12a. As a result, even when the amount of the deposit of metal zinc increases to increase the height of the deposit, it is less likely for the deposited metal zinc to reach the lower end of the positive electrode plate 12, resulting in making a short circuit S less likely to occur. Such an advantageous effect is realized when the height B from the bottom of the battery case 20 of the lower end of the negative electrode active material layer 14a is 2.0 to 8.0 mm, and the height difference A between the lower end of the positive electrode active material layer 12a and the lower end of the negative electrode active material layer 14a is 3.0 to 4.0 mm.

The height B from the bottom of the battery case 20 of the lower end of the negative electrode active material layer 14a is 2.0 to 8.0 mm, preferably 2.0 to 6.0 mm, more preferably 2.0 to 5.0 mm, further preferably 2.0 to 4.0 mm, and particularly preferably 2.0 to 3.0 mm. The height difference A between the lower end of the positive electrode active material layer 12a and the lower end of the negative electrode active material layer 14a is 3.0 to 4.0 mm, preferably 3.0 to 3.8 mm, more preferably 3.0 to 3.6 mm, further preferably 3.0 to 3.4 mm, and particularly preferably 3.0 to 3.2 mm.

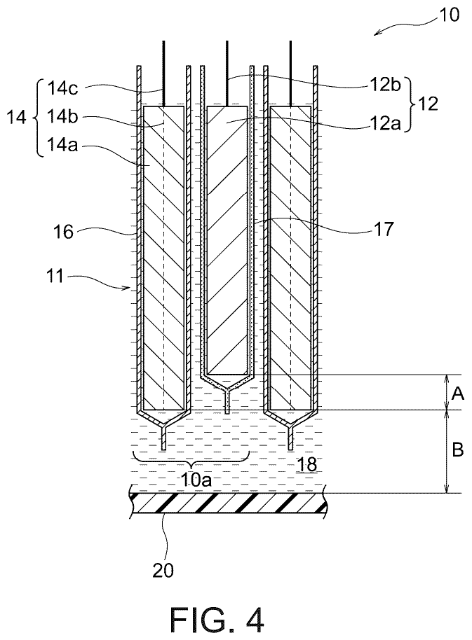

The positive electrode plate 12 includes the positive electrode active material layer 12a. A positive electrode active material contained in the positive electrode active material layer 12a is not especially limited, and may be appropriately selected from known positive electrode materials in accordance with the type of zinc secondary battery. For example, in a nickel-zinc secondary battery, a positive electrode containing nickel hydroxide and/or nickel oxyhydroxide may be used. Alternatively, in an air-zinc secondary battery, an air electrode may be used as the positive electrode. The positive electrode plate 12 further includes a positive electrode current collector (not shown), and the positive electrode current collector preferably has a positive electrode current collector tab 12b extending from an end (for example, an upper end) of the positive electrode plate 12. A preferred example of the positive electrode current collector includes a nickel porous substrate such as a foam nickel plate. In this case, for example, when a paste containing an electrode active material such as nickel hydroxide is uniformly applied on a nickel porous substrate, and the resultant is dried, a positive electrode plate including a positive electrode/positive electrode current collector can be favorably produced. At this point, it is also preferred that the dried positive electrode plate (namely, the positive electrode/positive electrode current collector) is subjected to pressing to prevent the electrode active material from coming off and to improve electrode density. Although the positive electrode plate 12 illustrated in FIGS. 4 and 5 includes a positive electrode current collector (of, for example, foam nickel), it is not illustrated therein. This is because the positive electrode current collector and the positive electrode active material are completely mixed in a nickel-zinc secondary battery, and hence the positive electrode current collector cannot be individually illustrated. The zinc secondary battery 10 preferably further includes a positive electrode current collector plate connected to a tip of the positive electrode current collector tab 12b, and more preferably, a plurality of positive electrode current collector tabs 12b are connected to one positive electrode current collector plate. In this manner, current collection can be conducted with a simple configuration and with high space efficiency, and connection to the positive electrode terminal 26 can be eased. Besides, the positive electrode current collector plate itself may be used as the positive electrode terminal 26.

The positive electrode plate 12 may contain an additive that is at least one selected from the group consisting of a silver compound, a manganese compound, and a titanium compound, and thus, a positive electrode reaction for absorbing hydrogen gas generated through self-discharge reaction can be accelerated. Besides, the positive electrode plate 12 may further contain cobalt. Cobalt is contained in the positive electrode plate 12 preferably in the form of cobalt oxyhydride. In the positive electrode plate 12, cobalt functions as a conductive auxiliary agent to contribute to improvement of charge/discharge capacity.

The negative electrode plate 14 includes the negative electrode active material layer 14a. A negative electrode active material contained in the negative electrode active material layer 14a contains at least one selected from the group consisting of zinc, zinc oxide, a zinc alloy, and a zinc compound. The zinc may be contained in any form of a zinc metal, a zinc compound, and a zinc alloy as long as it has electrochemical activity suitable for the negative electrode. Preferred examples of the negative electrode material include zinc oxide, a zinc metal, and calcium zincate, and a mixture of a zinc metal and zinc oxide is more preferred. The negative electrode active material may be in the form of a gel, or may be mixed with the electrolytic solution 18 to obtain a negative electrode mixture. For example, a gelled negative electrode can be easily obtained by adding an electrolytic solution and a thickener to a negative electrode active material. Examples of the thickener include polyvinyl alcohol, polyacrylate, CMC, and alginic acid, and polyacrylic acid is preferred because of excellent chemical resistance to strong alkali.

As the zinc alloy, a zinc alloy containing neither mercury nor lead, known as mercury-free zinc alloy, can be used. For example, a zinc alloy containing 0.01 to 0.1% by mass of indium, 0.005 to 0.02% by mass of bismuth, and 0.0035 to 0.015% by mass of aluminum is preferred because it has an effect of inhibiting hydrogen gas generation. In particular, indium and bismuth are advantageous in improving discharge performance. When a zinc alloy is used in the negative electrode, a self-dissolution rate in an alkaline electrolytic solution is decreased to inhibit hydrogen gas generation, and thus, safety can be improved.

The shape of the negative electrode material is not especially limited, and is preferably a powder shape, and thus, the surface area is increased to cope with large current discharge. A preferred average particle size of the negative electrode material is, in using a zinc alloy, in a range of 3 to 100 μm in minor axis, and when the average particle size is within this range, the surface area is so large that large current discharge can be suitably coped with, and in addition, the material can be easily homogeneously mixed with an electrolytic solution and a gelling agent, and handleability in assembling the battery is favorable.

The negative electrode plate 14 (excluding a portion thereof extending as a negative electrode current collector tab 14c) may include a negative electrode current collector 14b provided inside and/or on the surface of the negative electrode active material layer 14a. In other words, the negative electrode active material layer 14a may be arranged on both surfaces of the negative electrode current collector 14b, or the negative electrode active material layer 14a may be arranged on merely one surface of the negative electrode current collector 14b. It is preferred that the negative electrode plate 14 further includes the negative electrode current collector 14b, and the negative electrode current collector 14b has the negative electrode current collector tab 14c extending from an end (for example, an upper end) of the negative electrode plate 14. The negative electrode current collector tab 14c is provided preferably in a position not overlapping with the positive electrode current collector tab 12b. The zinc secondary battery 10 preferably further includes a negative electrode current collector plate connected to a tip of the negative electrode current collector tab 14c, and more preferably, a plurality of negative electrode current collector tabs 14c are connected to one negative electrode current collector plate. In this manner, current collection can be conducted with a simple configuration and with high space efficiency, and connection to the negative electrode terminal 28 can be eased. Besides, the negative electrode current collector plate itself may be used as the negative electrode terminal 28.

The negative electrode current collector 14b preferably uses a metal plate having a plurality of (or a large number of) openings from the viewpoint of fixing the negative electrode active material on the current collector. Preferred examples of such a negative electrode current collector 14b include an expanded metal, a punched metal, a metal mesh, and a combination thereof, more preferred examples include a copper expanded metal, a copper punched metal, and a combination thereof, and a particularly preferred example includes a copper expanded metal. In this case, for example, a negative electrode plate including a negative electrode/negative electrode collector can be favorably produced by applying, on a copper expanded metal, a mixture containing a zinc oxide powder and/or a zinc powder, and optionally a binder (for example, a polytetrafluoroethylene particle). At this point, it is also preferred that the dried negative electrode plate (namely, the negative electrode/negative electrode current collector) is subjected to pressing to prevent the electrode active material from coming off and to improve electrode density. An expanded metal refers to a mesh-shaped metal plate obtained by forming and expanding staggered cuts in a metal plate with an expanded metal machine, and shaping the cuts into a diamond shape or a hexagonal shape. A punched metal is also designated as a perforated metal, and refers to a metal plate provided with holes by punching. A metal mesh is a metal product having a wire mesh structure, and is different from an expanded metal and a punched metal.

The hydroxide ion conductive separator 16 is in a bag-like form for housing the negative electrode plate 14 therein, and is provided to separate the positive electrode plate 12 and the negative electrode plate 14 such that hydroxide ions can be conducted. A typical bag-like hydroxide ion conductive separator 16 has a rectangular outline (in a plan view), and is formed in a bag-like shape by sealing and/or folding three sides of the periphery, and the remaining one side is opened for allowing the negative electrode current collector tab 14c to extend therethrough. The hydroxide ion conductive separator 16 in the bag-like form for housing the negative electrode plate 14 therein can be a known one as those disclosed in Patent Literatures 6 and 7. As a result, as illustrated in FIGS. 4 and 5, the negative electrode plate 14 is configured to be covered or wrapped up with the hydroxide ion conductive separator 16. When such a configuration is employed, complicated sealing and bonding between the hydroxide ion conductive separator 16 and a battery container is unnecessary, and hence a nickel-zinc secondary battery (especially a stacked-cell battery thereof) capable of preventing zinc dendrite propagation can be produced extremely easily and with high productivity. Besides, the positive electrode plate 12 may be also configured to be covered or wrapped up with the hydroxide ion conductive separator 16. The bag-like hydroxide ion conductive separator 16 preferably includes a lower end sealing portion in which portions of the hydroxide ion conductive separator 16 are sealed by thermal welding or ultrasonic welding. It is preferred to perform the thermal welding of the portions of the hydroxide ion conductive separator 16 with a nonwoven fabric, used as a liquid holding member 17, sandwiched between the portions of the hydroxide ion conductive separator 16 because the welding can be effectively conducted by allowing the nonwoven fabric to function as a paste. On the other hand, when the ultrasonic welding is conducted, the portions of the hydroxide ion conductive separator 16 can be directly welded.

The hydroxide ion conductive separator 16 is not especially limited as long as it is a separator capable of separating the positive electrode plate 12 and the negative electrode plate 14 such that hydroxide ions can be conducted, and representatively is a separator that contains a hydroxide ion conductive solid electrolyte, and selectively passes hydroxide ions by solely utilizing hydroxide ion conductivity. A preferred hydroxide ion conductive solid electrolyte is a layered double hydroxide (LDH) and/or an LDH-like compound. Accordingly, the hydroxide ion conductive separator 16 is preferably an LDH separator. The “LDH separator” herein is a separator containing an LDH and/or an LDH-like compound, and is defined as a separator that selectively passes hydroxide ions by solely utilizing hydroxide ion conductivity of the LDH and/or the LDH-like compound. The “LDH-like compound” herein is a hydroxide and/or oxide having a layered crystal structure analogous to LDH but is a compound that may not be called LDH, and it can be said to be an equivalent of LDH. However, according to a broad sense of definition, it can be appreciated that “LDH” encompasses not only LDH but also LDH-like compounds.

The LDH separator is preferably composited with a porous substrate. Accordingly, it is preferred that the LDH separator further includes a porous substrate, and is composited with the porous substrate with the LDH and/or the LDH-like compound filled in pores in the porous substrate. In other words, in a preferred LDH separator, the LDH and/or the LDH-like compound clogs up pores in the porous substrate so that hydroxide ion conductivity and gas impermeability can be exhibited (thereby the LDH separator can function as an LDH separator exhibiting hydroxide ion conductivity). The porous substrate is preferably made of a polymer material, and the LDH is particularly preferably incorporated over the entire area in the thickness direction of the porous substrate made of a polymer material. For example, known LDH separators disclosed in Patent Literatures 1 to 7 can be used. The thickness of the LDH separator is preferably 5 to 100 μm, more preferably 5 to 80 μm, further preferably 5 to 60 μm, and particularly preferably 5 to 40 μm.

It is preferred that not only the hydroxide ion conductive separator 16 but also the liquid holding member 17 is interposed between the positive electrode plate 12 and the negative electrode plate 14. Then, the positive electrode plate 12 and/or the negative electrode plate 14 is preferably covered or wrapped up with the liquid holding member 17. A simple configuration in which the liquid holding member 17 is arranged on one side of the positive electrode plate 12 or the negative electrode plate 14 may be employed. In either configuration, since the liquid holding member 17 is thus interposed, the electrolytic solution 18 can be uniformly present between the positive electrode plate 12 and/or the negative electrode plate 14, and the hydroxide ion conductive separator 16, and thus, hydroxide ions can be efficiently transferred between the positive electrode plate 12 and/or the negative electrode plate 14, and the hydroxide ion conductive separator 16. The liquid holding member 17 is not especially limited as long as it is a member capable of holding the electrolytic solution 18, and is preferably a sheet-shaped member. Preferable examples of the liquid holding member 17 include a nonwoven fabric, a water-absorbent resin, a liquid retaining resin, a porous sheet, and various spacers, and a nonwoven fabric is particularly preferred because a good performance negative electrode structure can be produced at low cost. The liquid holding member 17 or the nonwoven fabric has a thickness of preferably 10 to 200 μm, more preferably 20 to 200 μm, further preferably 20 to 150 μm, particularly preferably 20 to 100 μm, and most preferably 20 to 60 μm. When the thickness falls in this range, with the entire size of the positive electrode structure and/or the negative electrode structure efficiently suppressed to be compact, a sufficient amount of the electrolytic solution 18 can be held in the liquid holding member 17.

When the positive electrode plate 12 and/or the negative electrode plate 14 are covered or wrapped up with the liquid holding member 17 and/or the separator 16, outer edges thereof (excluding a side on which the positive electrode current collector tab 12b or the negative electrode current collector tab 14c is extended) are preferably closed. In this case, closed sides of the outer edges of the liquid holding member 17 and/or the separator 16 are preferably realized by bending the liquid holding member 17 and/or the separator 16, or sealing the edges of the liquid holding member 17 and/or the edges of the separator 16. Preferred examples of the sealing method include an adhesive, thermal welding, ultrasonic welding, an adhesive tape, a sealing tape, and a combination thereof. In particular, an LDH separator including a porous substrate made of a polymer material has flexibility, and hence is advantageously easily bent, and therefore, it is preferred that the LDH separator formed into a rectangular shape is bent to obtain a state where one side of the outer edges is closed. For thermal welding and ultrasonic welding, a commercially available heat sealer or the like may be used, and in sealing the edges of an LDH separator, it is preferred to perform the thermal welding and the ultrasonic welding with an outer circumferential portion of the liquid holding member 17 sandwiched between outer circumferential portions of the LDH separator because the sealing can be thus more effectively performed. On the other hand, as an adhesive, an adhesive tape, and a sealing tape, commercially available products may be used, and in order to prevent deterioration otherwise caused in an alkaline electrolytic solution, one containing an alkali resistant resin is preferred. From this point of view, preferred examples of the adhesive include an epoxy resin-based adhesive, a natural resin-based adhesive, a modified olefin resin-based adhesive, and a modified silicone resin-based adhesive, among which an epoxy resin-based adhesive is more preferred because of excellent alkali resistance. An example of products of the epoxy resin-based adhesive includes an epoxy adhesive, Hysol® (manufactured by Henkel).

The outer edge on one side corresponding to the upper edge of the separator 16 is preferably opened. Such a top open type configuration makes it possible to deal with a problem occurring upon overcharge in a nickel-zinc battery and the like. Specifically, when a nickel-zinc battery or the like is overcharged, oxygen (O₂) can be generated in the positive electrode plate 12, but the LDH separator has such a high density as to substantially pass only hydroxide ions, and hence does not pass O₂. In this regard, when the above-described top open type configuration is employed, O₂ can be transferred above the positive electrode plate 12 to be sent toward the negative electrode plate 14 through the top open portion in the battery case 20, and thus, Zn of a negative electrode active material can be oxidized with the O₂ to be restored to ZnO. Owing to such an oxygen reaction cycle, overcharge resistance can be improved by using top open type battery components 11 in a sealed zinc secondary battery. Even when the outer edge on one side corresponding to the upper edge of the separator 16 or the liquid holding member 17 is closed, the same effect as that obtained by the open type configuration can be expected by providing a vent hole in a part of the closed outer edge. For example, a vent hole may be formed after sealing the outer edge on one side corresponding to the upper edge of the LDH separator, or a part of the outer edge may be left unsealed in sealing so as to form a vent hole therein.

The electrolytic solution 18 preferably contains an alkali metal hydroxide aqueous solution. Although the electrolytic solution 18 is merely locally illustrated in FIGS. 4 and 5, this is because the electrolytic solution spreads all over the positive electrode plate 12 and the negative electrode plate 14. Examples of an alkali metal hydroxide include potassium hydroxide, sodium hydroxide, lithium hydroxide, and ammonium hydroxide, and potassium hydroxide is more preferred. In order to inhibit self-dissolution of zinc and/or zinc oxide, a zinc compound such as zinc oxide, or zinc hydroxide may be added to the electrolytic solution. As described above, the electrolytic solution may be mixed with the positive electrode active material and/or the negative electrode active material so as to be present in the form of a positive electrode mixture and/or a negative electrode mixture. Besides, the electrolytic solution may be gelled for preventing leakage of the electrolytic solution. As a gelling agent, a polymer that absorbs a solvent of the electrolytic solution to swell is preferably used, and a polymer such as polyethylene oxide, polyvinyl alcohol, or polyacrylamide, or starch is used.

The battery components 11 are preferably formed into a positive/negative electrode laminate including a plurality of positive electrode plates 12, a plurality of negative electrode plates 14, and a plurality of separators 16 in which a unit of the positive electrode plate 12/the separator 16/the negative electrode plate 14 is repeatedly stacked. In other words, the zinc secondary battery 10 includes a plurality of unit cells 10a, and thus, the plurality of unit cells 10a preferably form a multilayer cell as a whole. This is a configuration of what is called a battery pack or stacked cell battery, and this configuration is advantageous in obtaining a high voltage and a large current.

The battery case 20 is preferably made of a resin. The resin constituting the battery case 20 is preferably a resin having resistance to an alkali metal hydroxide such as potassium hydroxide, more preferably a polyolefin resin, an ABS resin, or modified polyphenylene ether, and further preferably an ABS resin or modified polyphenylene ether. The battery case 20 has a top cover 20a. The battery case 20 (for example, the top cover 20a) may have a pressure release valve for releasing a gas. Besides, a case group in which two or more battery cases 20 are arranged may be housed in an outer frame to obtain a configuration of a battery module.

### LDH-Like Compounds

According to a preferred aspect of the present invention, the LDH separator can be a separator that contains an LDH-like compound. The definition of the LDH-like compound is as described above. Preferred LDH-like compounds are as follows,
(a) a hydroxide and/or oxide having a layered crystal structure containing Mg and one or more elements selected from the group consisting of Ti, Y, and Al, and containing at least Ti; or
(b) a hydroxide and/or oxide having a layered crystal structure containing (i) Ti, Y, optionally Al and/or Mg, and (ii) at least one additive element M selected from the group consisting of In, Bi, Ca, Sr and Ba, or
(c) a hydroxide and/or oxide having a layered crystal structure containing Mg, Ti, Y, optionally Al and/or In, wherein in (c), the LDH-like compound is present in a form of mixture with In(OH)₃.

According to the preferred aspect (a) of the present invention, the LDH-like compound can be a hydroxide and/or oxide having a layered crystal structure containing Mg and one or more elements selected from the group consisting of Ti, Y and Al and containing at least Ti. Thus, a typical LDH-like compound is a complex hydroxide and/or complex oxide of Mg, Ti, optionally Y and optionally Al. The above elements may be replaced with other elements or ions to an extent that the basic characteristics of the LDH-like compound are not impaired, but the LDH-like compound preferably contains no Ni. For example, the LHD-like compound may be a compound further containing Zn and/or K. In such a manner, ionic conductivity of the LDH separator can be further improved.

LDH-like compounds can be identified by X-ray diffraction. Specifically, when X-ray diffraction is carried out on the surface of the LDH separator, a peak assigned to the LDH-like compound is detected typically in the range of 5°≤2θ≤10°, and more typically in the range of 7°≤2θ≤10°. As described above, the LDH is a substance having an alternating laminated structure in which exchangeable anions and H₂O are present as an intermediate layer between the stacked hydroxide basic layers. In this regard, when LDH is analyzed by the X-ray diffraction method, a peak assigned to the crystal structure of LDH (i.e., the peak assigned to (003) of LDH) is originally detected at a position of 2θ=11 to 12°. When the LDH-like compound is analyzed by the X-ray diffraction method, on the other hand, a peak is typically detected in the aforementioned range shifted to the lower angle side than the above peak position of LDH. Further, the interlayer distance of the layered crystal structure can be determined by Bragg's equation using 2θ corresponding to the peak assigned to the LDH-like compound in X-ray diffraction. The interlayer distance of the layered crystal structure of the LDH-like compound thus determined is typically 0.883 to 1.8 nm, and more typically 0.883 to 1.3 nm.

The LDH separator by the aforementioned aspect (a) has an atomic ratio of Mg/(Mg+Ti+Y+Al) in the LDH-like compound, as determined by energy dispersive X-ray spectroscopy (EDS), which is preferably 0.03 to 0.25 and more preferably 0.05 to 0.2. Moreover, the atomic ratio of Ti/(Mg+Ti+Y+Al) in the LDH-like compound is preferably 0.40 to 0.97 and more preferably 0.47 to 0.94. Further, the atomic ratio of Y/(Mg+Ti+Y+Al) in the LDH-like compound is preferably 0 to 0.45 and more preferably 0 to 0.37. Further, the atomic ratio of Al/(Mg+Ti+Y+Al) in the LDH-like compound is preferably 0 to 0.05 and more preferably 0 to 0.03. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another preferred aspect (b) of the present invention, the LDH-like compound can be a hydroxide and/or oxide having a layered crystal structure containing (i) Ti, Y, and optionally Al and/or Mg and (ii) additive element M. Therefore, a typical LDH-like compound is a complex hydroxide and/or complex oxide of Ti, Y, additive element M, optionally Al and optionally Mg. Additive element M is In, Bi, Ca, Sr, Ba or combinations thereof. The above elements may be replaced with other elements or ions to an extent such that the basic characteristics of the LDH-like compound are not impaired, but the LDH-like compound preferably contains no Ni.

The LDH separator by the aforementioned aspect (b) has an atomic ratio of Ti/(Mg+Al+Ti+Y+M) in the LDH-like compound, as determined by energy dispersive X-ray spectroscopy (EDS), which is preferably 0.50 to 0.85 and more preferably 0.56 to 0.81. The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to 0.10 and more preferably 0 to 0.02. Then, the atomic ratio of Al/(Mg+Al+Ti+Y+M) in the LDH-like compound is preferably 0 to 0.05 and more preferably 0 to 0.04. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another further preferred aspect (c) of the present invention, the LDH-like compound can be a hydroxide and/or oxide having a layered crystal structure containing Mg, Ti, Y, and optionally Al and/or In, wherein the LDH-like compound is present in a form of mixture with In(OH)₃. The LDH-like compound in this aspect is a hydroxide and/or oxide having a layered crystal structure containing Mg, Ti, Y, and optionally Al and/or In. Therefore, a typical LDH-like compound is a complex hydroxide and/or complex oxide of Mg, Ti, Y, optionally Al and optionally In. The In that can be contained in the LDH-like compound may be not only In intentionally added to the LDH-like compound but also that unavoidably mixed into the LDH-like compound, due to formation of In(OH)₃ or the like. The above elements can be replaced with other elements or ions to an extent that the basic characteristics of the LDH-like compound are not impaired, however, the LDH-like compound preferably contains no Ni. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH.

The mixture by the above aspect (c) contains not only the LDH-like compound but also In(OH)₃ (typically composed of the LDH-like compound and In(OH)₃). In(OH)₃ contained can effectively improve alkali resistance and dendrite resistance in LDH separators. The content proportion of In(OH)₃ in the mixture is preferably the amount that can improve alkali resistance and dendrite resistance with little impairment of hydroxide ion conductivity of the LDH separator, and is not particularly limited. In(OH)₃ may have a cubic crystal structure, and have a configuration in which the crystals of In(OH)₃ are surrounded by LDH-like compounds. In(OH)₃ can be identified by X-ray diffraction.

### EXAMPLES

The present invention will be more specifically described with reference to the following examples.

### Examples 1 to 6

### (1) Production of Nickel-Zinc Secondary Battery

The following positive electrode plate, negative electrode plate, LDH separator, nonwoven fabric, airtight container, and electrolytic solution were prepared.
Positive electrode plate: one obtained by filling pores of foam nickel with a positive electrode paste containing nickel hydroxide and a binder, number of plates: 13
Negative electrode plate: one obtained by pressure-bonding, to a current collector (copper expanded metal), a paste containing a ZnO powder, a metal Zn powder, polytetrafluoroethylene (PTFE), and propylene glycol, number of plates: 14
LDH separator: one obtained by precipitating Ni-AI-Ti-LDH (layered double hydroxide) in pores and on the surface of a polyethylene microporous film by hydrothermal synthesis, and roll-pressing the resultant, thickness: 0.009 mm
Nonwoven fabric: made of polyethylene
Airtight container: a housing made of modified polyphenylene ether resin (equipped with a pressure relief valve capable of releasing gas generated therein)
Electrolytic solution: 5.4 mol/L KOH aqueous solution containing 0.4 mol/L ZnO dissolved therein

In accordance with the configuration illustrated in FIGS. 1 to 4, a negative electrode structure opened on the upper side was obtained by wrapping up the negative electrode plate with the LDH separator, and sealing three sides excluding the upper end side by thermal welding with the nonwoven fabric interposed between portions of the LDH separator, and a positive electrode structure opened on the upper side was obtained by wrapping up the positive electrode plate with the nonwoven fabric, and sealing three sides excluding the upper end side by thermal welding. The thus prepared positive electrode structures and the negative electrode structures in the total number of 27 were put in the airtight container in such a manner as to be alternately positioned. Here, the height difference A between the lower end of the positive electrode active material layer and the lower end of the negative electrode active material layer, and the height B from the bottom of the battery case of the lower end of the negative electrode active material layer were set respectively to values show in Table 1. A positive electrode current collector tab extending upward from a positive electrode current collector was connected to a positive electrode terminal, and a negative electrode current collector tab extending upward from a negative electrode current collector was connected to a negative electrode terminal, and the container was closed. The electrolytic solution was added through a solution port, and after the electrolytic solution was sufficiently infiltrated into the positive electrode plate and the negative electrode plate by vacuuming, the solution port was closed. In this manner, a multilayer cell type nickel-zinc secondary battery was obtained.

### (2) Cycle Test

A charge/discharge device (TOSCAT3100, manufactured by Toyo System Co., Ltd.) was used for subjecting a simple closed cell to chemical conversion by charge at 0.1 C and discharge at 0.2 C. Thereafter, a 0.5 C charge/discharge cycle was conducted up to 200 times unless a capacity retention rate to an initial discharge capacity was lower than 70%, and it was confirmed whether or not a short circuit occurred. Results are shown in Table 1.

### [Table 1]

TABLE 1

| | Height difference A | | Evaluation |
|---|---|---|---|
| | (mm) between lower end | Height B (mm) from | of charge/ |
| | of positive electrode | bottom of battery | discharge cycle |
| | active material layer | case of lower end | (occurrence of |
| | and lower end of | of negative | short circuit |
| | negative electrode | electrode active | up to 200 |
| | active material layer | material layer | cycles) |
| Ex. 1 | 3.0 | 7.5 | not occur |
| Ex. 2 | 4.0 | 2.5 | not occur |
| Ex. 3 | 3.0 | 5.0 | not occur |
| Ex. 4* | 1.0 | 5.0 | occur |
| Ex. 5* | 4.0 | 1.0 | occur |
| Ex. 6* | 1.0 | 1.0 | occur |

*Comparative example

What is claimed is:

1. A zinc secondary battery comprising:
a positive electrode plate including a positive electrode active material layer;
a negative electrode plate including a negative electrode active material layer containing at least one selected from the group consisting of zinc, zinc oxide, a zinc alloy, and a zinc compound;
a hydroxide ion conductive separator that is in a bag-like form for housing the negative electrode plate therein, and separates the positive electrode plate and the negative electrode plate so as to make hydroxide ions conductable;
an electrolytic solution; and
a battery case in which the positive electrode plate, the negative electrode plate, and the hydroxide ion conductive separator are vertically housed,
wherein the negative electrode active material layer extends to a position lower than a lower end of the positive electrode active material layer, and
wherein a height from a bottom of the battery case of a lower end of the negative electrode active material layer is 2.0 to 8.0 mm, and a height difference between the lower end of the positive electrode active material layer and the lower end of the negative electrode active material layer is 3.0 to 4.0 mm.

2. The zinc secondary battery according to claim 1, wherein the bag-like hydroxide ion conductive separator includes a lower end sealing portion sealed by thermal welding or ultrasonic welding of portions of the hydroxide ion conductive separator.

3. The zinc secondary battery according to claim 1, wherein not only the hydroxide ion conductive separator but also a liquid holding member is interposed between the positive electrode plate and the negative electrode plate.

4. The zinc secondary battery according to claim 3, wherein the positive electrode plate and/or the negative electrode plate is covered or wrapped up with the liquid holding member.

5. The zinc secondary battery according to claim 3, wherein the liquid holding member is a nonwoven fabric.

6. The zinc secondary battery according to claim 5, wherein the nonwoven fabric has a thickness of 10 to 200 μm.

7. The zinc secondary battery according to claim 1, wherein the hydroxide ion conductive separator is an LDH separator containing a layered double hydroxide (LDH) and/or an LDH-like compound.

8. The zinc secondary battery according to claim 7, wherein the LDH separator further includes a porous substrate, and is composited with the porous substrate with the LDH and/or the LDH-like compound filled in pores in the porous substrate.

9. The zinc secondary battery according to claim 8, wherein the porous substrate is made of a polymer material.

10. The zinc secondary battery according to claim 7, wherein the LDH separator has a thickness of 5 to 100 μm.

11. The zinc secondary battery according to claim 1, wherein the positive electrode active material layer contains nickel hydroxide and/or nickel oxyhydroxide, whereby the zinc secondary battery is configured as a nickel-zinc secondary battery.

12. The zinc secondary battery according to claim 1, wherein the positive electrode active material layer is an air electrode layer, whereby the zinc secondary battery is configured as an air-zinc secondary battery.

13. The zinc secondary battery according to claim 1, comprising a plurality of unit cells each including a pair of the positive electrode plate and the negative electrode plate together with the hydroxide ion conductive separator, whereby the plurality of the unit cells form a multilayer cell as a whole.
